(19) United States
(12) Patent Application Publication
(10) Pub. No.: US 2011/0254766 A1
(43) Pub. Date: Oct. 20, 2011

(54) COMPUTER MOUSE CABLE REEL STOWAGE DEVICE

(76) Inventor: WEN-HAN CHANG, Taipei City (TW)

(21) Appl. No.: 12/763,222

(22) Filed: Apr. 20, 2010

(51) Int. Cl. G06F 3/033; H01R 13/72

(52) U.S. Cl. 345/163; 439/501

(57) ABSTRACT

Disclosed is a computer mouse cable reel stowage device, which ingeniously stows a computer mouse cable reel inside the structure of a computer mouse, whereby a cabled mouse and a reel that is provided for winding and releasing the mouse cable are integrated in a single combined structure to allow for easy and simultaneous carrying. Thus, the two devices of cable mouse and cable reel can be always of the simultaneity in carrying and use to ensure synergy effect of use.

### (a) TECHNICAL FIELD OF THE INVENTION

The present invention generally relates to a computer mouse cable reel stowage device, which is designed to provide a construction that, besides the essential function of retraction and extension of a mouse cable, allows a mouse cable reel to be stowed in a stowage chamber formed in the bottom of a computer mouse, so that the cable reel, when needed, is integrated, as a unitary device, to the computer mouse for easy carrying and use.

It is known in the technical field in association with the present invention that a reel device for winding a mouse cable is available for overcoming the inconvenience of cable entanglement and obstruction caused by the length of the mouse cable connected to a computer mouse in order to provide an advantage of easy retraction and extension to the mouse cable. Meanwhile, the cable reel is provided with a through of integration and combination that allows the reel to be stowed in a bottom of a computer mouse for ease and convenience of carrying and use, so that the two devices of computer mouse and cable reel are prevented from undesired separation and loss.

On the other hand, the present invention provides a computer mouse cable reel stowage device that is configured on the basis of the bottom of a wireless computer mouse, particularly without affecting the spatial arrangement and configuration of internal components of the wireless computer mouse, in such a way that a stowage chamber is formed, in a longitudinal direction, in the bottom of the wireless computer mouse to closely receive and retain the cable reel. Further, the stowage chamber is constructed to comprise a cable guide slot that guides movement of the mouse cable so as to facilitate smoothness and ease of retraction and extension of the mouse cable by the cable reel.

As desired and required in structural arrangement of the cable reel according to the present invention, adaption of ends of the mouse cable carried by the cable reel must be made to related components, whereby one of the cable ends is fixedly connected to a circuit board of a computer mouse so as to make the cable reel a constituent component of the mouse and allow the cable reel to wind and store the mouse cable inside the cable reel, while the other end of the cable is configured to allow for selective connection with an access port (USB) of a computer and is thus formed as a USB connection terminal. Based on inference from such an arrangement, in addition to the basic function of retraction and extension of mouse cable, the cable reel according to the present invention allows for the arrangement of cable reels carrying various lengths of mouse cable in order to meet the need for cables of different lengths.

According to the basic idea of the present invention, pronounced effects related to carrying, stowage, and use are provided by a cable reel that carries a mouse cable and also, the following considerations are also taken:
(1) realizing simplicity, ease of use, and excellent functional value for practical purposes;
(2) not adding any burden in association with modification of the structure of a wireless computer mouse so as to provide a stowage space of excellent functionality;
(3) taking into consideration for mass production and tolerance of cost under the practical requirement for practicability and simplification; and
(4) providing an excellent adaptability for cable reel so as to allow for adoption of reels carrying various lengths of mouse cable to suit the need for the maximum range of variation of length of mouse cable.

### (b) DESCRIPTION OF THE PRIOR ART

Recently, various types of computer mice are fast developed and sold in the market. These mice are generally of two categories, either cabled mice or wireless mice. Although a wireless mouse is of better operability and convenience than a cabled one, yet the stability of operation and supply of power are still of severe problems to overcome. On the other hand, the cabled mouse often suffers entanglement and obstruction of a mouse cable connected thereto, leading to trouble and inconvenience of use.

For all types of cable mouse currently available in the market, the mouse cable is a must component of the cabled mouse and is the major stream of the currently available cabled mice. The trend of miniaturization and improved precision for the cable of the cabled mouse is the current major challenge for the computer mouse industry and improvement in these respects has not been found in the market for a very long while. Thus, the cable only functions for transmission and connection and other functional improvement in respect of for example integration and stowage has never been put into consideration in this field. Consequently, although being a mature product, the cabled mouse is still struggling for convenient storage and selection of proper length of the cable, which always trouble the general consumers. Apparently, any breakthrough in the arrangement of mouse cable connected to a computer mouse would be of much value in improving market competition power of mouse product and also shows benefits in practical operation of computer mouse.

A cabled mouse with single-direction retraction and extension of mouse cable is available in the market, wherein the mouse cable is stowed inside the computer mouse through a cable reel. The function of retraction and extension provided by the cable reel shows a significant practical value of retracting and extending a mouse cable. Such a known device is of high practical value and ease of use, but the lifespan of the computer mouse is affected by the product quality of the internally hidden cable reel. Any damage of the cable reel or any undesired separation of connection point of the cable would lead to termination of the lifespan of the mouse. This certainly deteriorates the value of a computer mouse. Further, due to the current trend of miniaturization of the computer mouse, the internal arrangement of the concealed cable reel is in fact an adverse factor for the computer mouse and is also a cause of undesired rise of cost. Further, insufficiency of cable length for the mouse cable carried by an internally stowed cable reel surely affects the operation of the mouse.

### SUMMARY OF THE INVENTION

Thus, the present invention provides a computer mouse cable reel stowage device, which allows for retraction and extension of a computer mouse cable and combines the cable reel with a mouse structure to form an integrated stowage structure, wherein the cable reel is received and stowed in a bottom of the computer mouse in such a way that stowing the reel is realized through an outside-to-inside depositing operation, while the retrieval of the reel is realized through an inside-to-outside removing operation. Thus, the operation and use of the computer mouse is of absolute convenience with three major advantages in respect of carrying, loss prevention, and wide universality of adaptation.

Thus, according to the present invention, the structure provided by the present invention mainly comprises a computer mouse and a cable reel, wherein the computer mouse has a bottom forming a stowage chamber that receives and stows the reel. The stowage chamber is composed of three accommodation spaces respectively for receiving and stowing a body of the reel, a USB connection terminal, and a cable guide slot. Besides the basic function of retraction and extension of the mouse cable, the configuration of the cable reel is set to correspond to the stowage chamber defined in the bottom of the computer mouse and is composed of two major constituent components including a reel body and a USB connection terminal. Due to the correspondence between the stowage chamber and the reel, the reel can be efficiently stowed in the bottom of the computer mouse to form a combined arrangement for easy carrying and use.

An important consideration addressed in the present invention is to realize the most pronounced effect with the simplest structure and accordingly, simplification of structure is a major issue of the present invention. With the above described arrangement, the present invention is apparently an innovation with synergy effect.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the bottom structure of a computer mouse according an embodiment of the present invention.

FIG. 2 is a schematic view showing the connection of a mouse cable reel according to the present invention to a mouse circuit board.

FIG. 3 is a schematic view showing the mouse cable reel according to the present invention removed out of the computer mouse.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

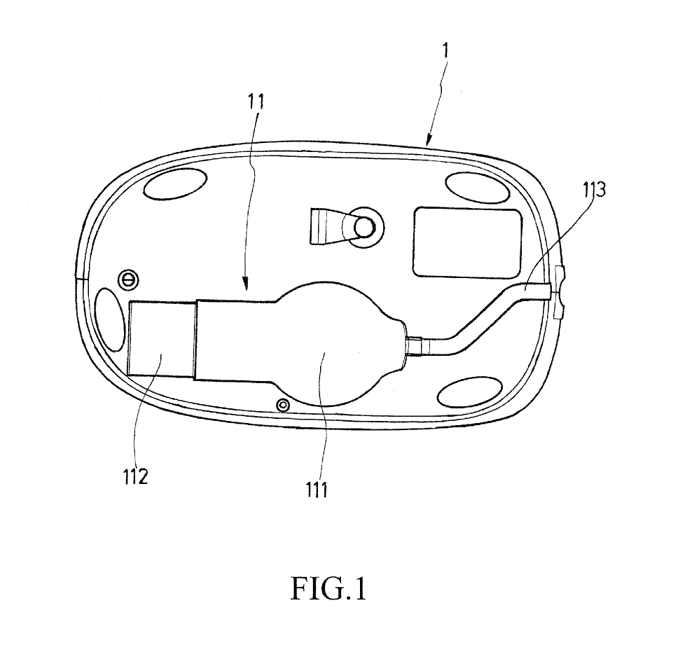

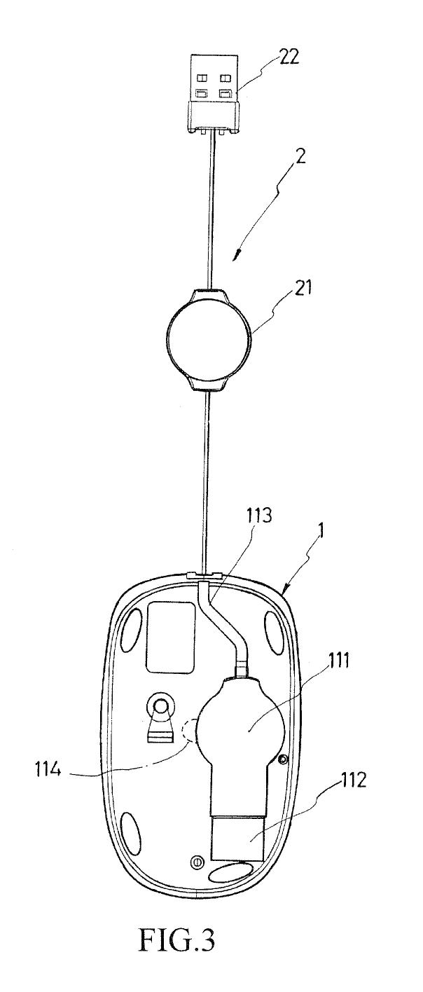

Referring to FIGS. 1 and 3, the present invention provides a structure that comprises a computer mouse 1 and a mouse cable reel 2. The computer mouse 1 has a bottom in which a stowage chamber 11 is formed in a longitudinal direction to show a configuration corresponding to the cable reel 2, whereby the cable reel 2 can be exactly received and stowed in the computer mouse 1 to provide a computer mouse structure that receives the cable reel 2 therein in a concealed manner.

Referring to FIG. 3, the stowage chamber 11 that is formed in the bottom of the computer mouse 1 according to the present invention is configured to correspond to the cable reel 2. The stowage chamber 11 is composed of a reel body accommodation space 111, a USB (Universal Serial Bus) connection terminal accommodation space 112, and a cable slot 113, which are in communication with each other. Further, the present invention may selectively and additionally form one or multiple recesses 114 in a side wall that delimits the reel body accommodation space 111, whereby when the cable reel 2 is received and stowed in the stowage chamber 11, the recess 114 allows for manual access and removal of the cable reel 2 out of the stowage chamber 11. This arrangement allows the bottom of the computer mouse 1 to maintain a planar surface even when the cable reel 2 is received and stowed in the computer mouse 1, whereby the operation and use of the computer mouse 1 is not affected by the stowage of the cable reel 2 therein.

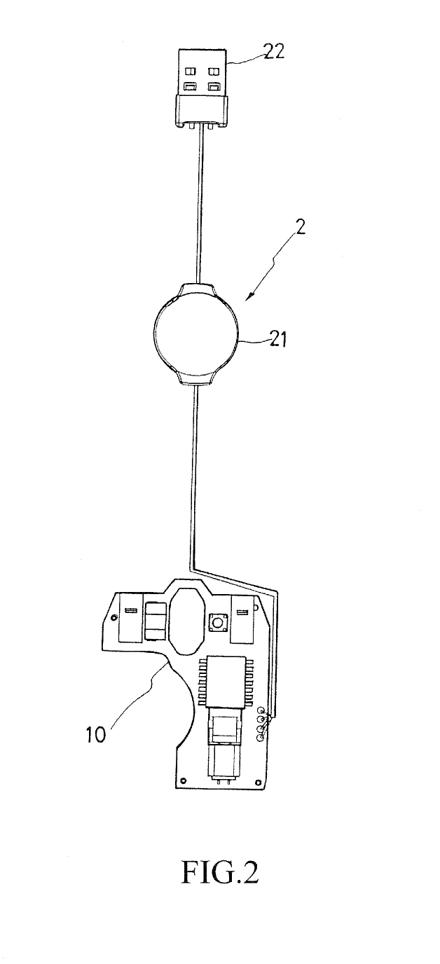

Referring to FIG. 2, the cable reel 2 according to the present invention is constructed to correspond to the stowage chamber 11 and is composed of two major constituent components, including a reel body 21 and a USB connection terminal 22. Based on the structural requirement for proper operation, the cable reel 2 comprises a computer mouse cable that is wound around the reel body 21 and has an end connected to a mouse circuit board 10, making the cable reel 2 a constituent portion of the complete structure of the computer mouse 1, and an opposite end that fulfills the need for releasable connection with a USB port of a computer and is thus provided with a USB connection terminal 22. Further, the cable reel 2 is constructed to allow for retraction and extension of the mouse cable and is selectively of a dual direction retraction/extension configuration. In operation, simply moving the computer mouse 1 makes the reel body of the cable reel 2 to wind or release the mouse cable in dual directions.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A computer mouse reel stowage device, comprising a computer mouse and a cable reel, characterized in that:
the computer mouse has a bottom in which a longitudinal stowage chamber is formed in a configuration that corresponds to and selectively receives and stows the cable reel therein; and
the cable reel is removably received and stowed in the stowage chamber formed in the bottom of the computer mouse and the cable reel carries a mouse cable having an end connected to a mouse circuit board and an opposite end forming a structure removably connectable to a USB port of a computer device.

2. The computer mouse reel stowage device according to claim 1, wherein the stowage chamber formed in the bottom of the computer mouse is composed of a reel body accommodation space, a USB connection terminal accommodation space, and a cable slot.

3. The computer mouse reel stowage device according to claim 1, wherein the stowage chamber formed in the bottom of the computer mouse comprises one or multiple recesses formed in a side wall that delimits the reel body accommodation space.

4. The computer mouse reel stowage device according to claim 1, wherein the cable reel is composed of a reel body and a USB connection terminal.

5. The computer mouse reel stowage device according to claim 1, wherein the cable reel allows for retraction/extension of the mouse cable in dual directions.
